(19) United States
(12) Patent Application Publication
(10) Pub. No.: US 2014/0119710 A1
(43) Pub. Date: May 1, 2014

(54) SCENE CONTROL SYSTEM AND METHOD AND RECORDING MEDIUM THEREOF

(71) Applicant: INSTITUTE FOR INFORMATION INDUSTRY, Taipei City (TW)

(72) Inventors: Pei-Wen HUANG, Taipei Cit (TW); Emery JOU, Taipei City (TW); Jing-Fung CHEN, New Taipei City (TW); Chia-Hsiang CHANG, Taipei City (TW)

(73) Assignee: INSTITUTE FOR INFORMATION INDUSTRY, Taipei City (TW)

(21) Appl. No.: 13/760,926

(22) Filed: Feb. 6, 2013

(30) Foreign Application Priority Data
Oct. 31, 2012 (TW) 101140355

(51) Int. Cl. H04N 9/87

(52) U.S. Cl. CPC H04N 9/87
USPC 386/241

(57) ABSTRACT

A scene control system and method and a recording medium thereof are provided. The system includes a media supply module, a time code unit, and a monitoring unit. The media supply module is used for supplying original scene information and spare scene information. The time code unit respectively obtains an original scene time code corresponding to the original scene information and a spare scene time code corresponding to the spare scene information. The monitoring unit is used for obtaining a control signal according to external ratings or through watching the original scene information downloaded in advance, and according to the control signal, processing an original scene picture of a segment unsuitable for watching in the original scene information through retrieval, content insertion, or pixelization, so as to avoid playing of an inappropriate picture.

### CROSS-REFERENCE TO RELATED APPLICATION

This application claims the benefit of Taiwan Patent Application No. 101140355, filed on Oct. 31, 2012, which is hereby incorporated by reference for all purposes as if fully set forth herein.

### BACKGROUND

1. Field of Invention

The present invention relates to a scene control system and method and a recording medium thereof, and more particularly to a scene control system and method and a recoding medium thereof that are capable of intercepting an inappropriate picture or arranging the insertion of an advertisement or video in place of an inappropriate picture during media playing.

2. Related Art

Generally speaking, television broadcast programs are usually prerecorded or pre-produced and then stored in tapes before being broadcast in public through wireless transmission at a broadcast time. Programs that are produced and broadcast by television stations or program tapes purchased by television stations are examined at different levels for program rating. However, sometimes inappropriate segments for children or juveniles might still be left in programs. For example, for some highly controversial cartoons, although the program contents are shown in a cartoon form, some pictures and conversations are inappropriate for children or juveniles to watch. In addition, if a parent avoids the playing of such program contents by switching channels, other contents of the channel may be missed upon the return.

As can be known from the above, the public can only receive program contents broadcast by television stations passively oftentimes, or switch channels to prevent children or juveniles of the family from watching inappropriate contents. Therefore, it is an urgent problem to be solved on how to provide a program control method featured by parent control and meanwhile capable of preventing other program contents from being missed.

### SUMMARY

To solve the above problem, the present invention discloses a scene control system and method and a recording medium thereof for a television program capable of active retrieval of a television program segment, content insertion or pixelization processing.

The scene control system disclosed by the present invention comprises a media supply module, a time code unit, and a monitoring unit.

The media supply module is used for supplying original scene information and spare scene information. The time code unit respectively obtains an original scene time code corresponding to the original scene information and a spare scene time code corresponding to the spare scene information. The monitoring unit is used for obtaining user information and a control signal, and according to the user information and the control signal, searching for the spare scene time code corresponding to the original scene time code and replacing the original scene information with the spare scene information.

The scene control method disclosed by the present invention comprises: supplying, by a media supply module, original scene information and spare scene information; respectively obtaining, by a time code unit, an original scene time code corresponding to the original scene information and a spare scene time code corresponding to the spare scene information; obtaining, by a monitoring unit, a control signal, and according to the control signal, searching for, by the monitoring unit, the spare scene time code corresponding to the original scene time code, and replacing the original scene information with the spare scene information for playing.

The present invention further discloses a recording medium, which enables an electronic apparatus to execute the above scene control method, where the process of steps of the method is described above and is not described herein again.

The present invention is characterized by the following features. First, by means of playing durations of various programs, for the content of a program watched by a user, the content of electronic media is checked in a preloading manner or with reference to the viewpoint of the public. Then a user is prevented from watching an inappropriate program content through film editing, content insertion or playing of a short video clip. Secondly, by means of targeted retrieval of a segment of original scene information, a user can manipulate the original scene information played by a multimedia playing device. In other words, the user is not limited to a fixed type of original scene information content, thereby reducing the influences of improper contents in the original scene information on children or juveniles. Thirdly, through targeted processing of played contents of original scene information, more approaches to avoid segments unsuitable for watching are provided in addition to the mere passive switching of channels for conventional television programs.

### BRIEF DESCRIPTION OF THE DRAWINGS

The present invention will become more fully understood from the detailed description given herein below for illustration only, and thus are not limitative of the present invention, and wherein:

FIG. 1 is a structural view of a scene control system according to an embodiment of the present invention;

FIG. 2 is a block view of elements of a scene control system according to an embodiment of the present invention;

FIG. 3 is a first detailed schematic structural view of a scene control system according to an embodiment of the present invention;

FIG. 4 is a second detailed schematic structural view of a scene control system according to an embodiment of the present invention;

FIG. 5 is a schematic process flow chart of a scene control method corresponding to FIG. 2;

FIG. 6 is another schematic process flow chart of a scene control method corresponding to FIG. 3;

FIG. 7 is yet another schematic process flow chart of a scene control method corresponding to FIG. 4;

FIG. 8 and FIG. 9 are detailed schematic flow charts of a scene control method according to an embodiment of the present invention; and

FIG. 10 and FIG. 11 are schematic views of a media playing tree structure of scene control according to an embodiment of the present invention.

### DETAILED DESCRIPTION

The embodiments of the present invention are illustrated below in detail with reference to the accompanying drawings.

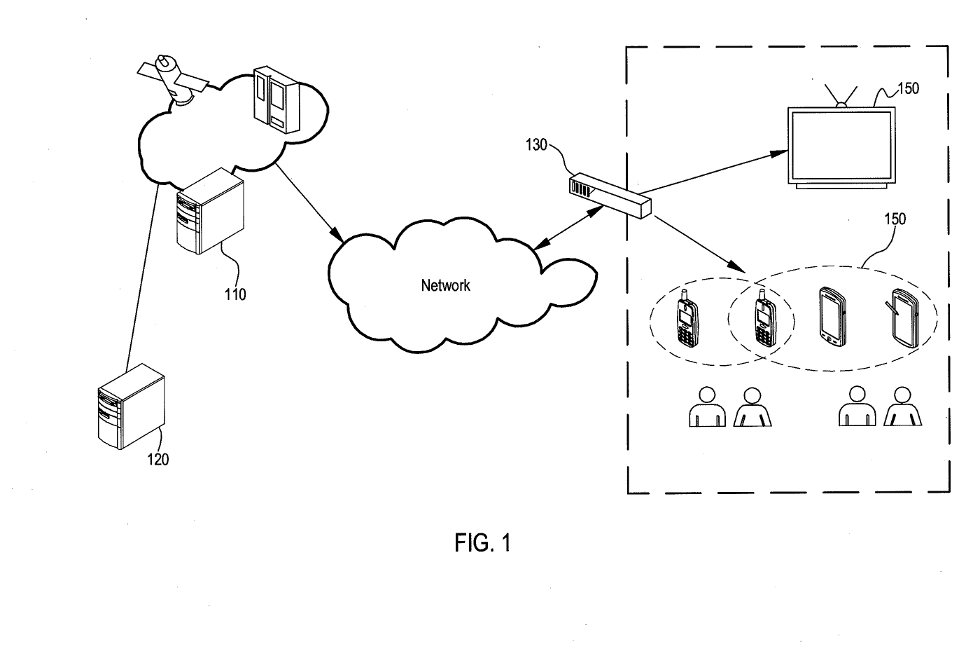

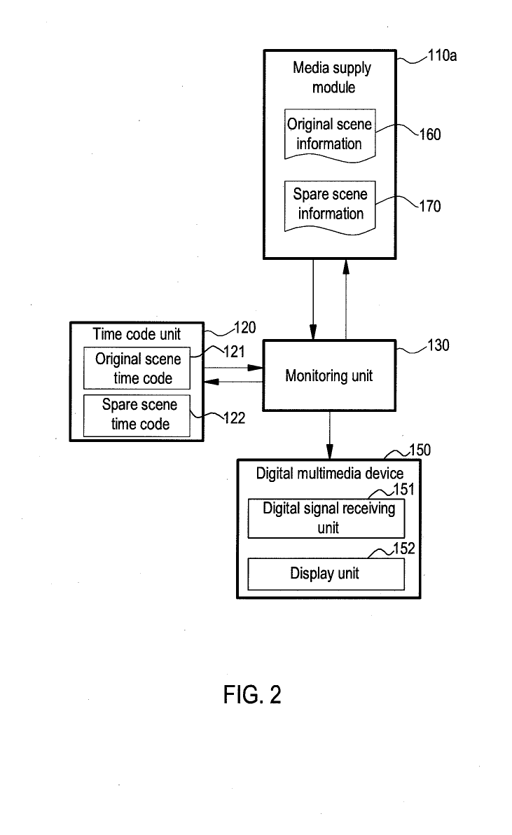

First, FIG. 1 is a structural view of a scene control system according to an embodiment of the present invention. FIG. 2 is a block view of elements of a scene control system according to an embodiment of the present invention. The system described in FIG. 1 and FIG. 2 can be applied to a device, apparatus, or system with a media playing capability, and the configuration form is not limited. The scene control system includes a media supply module 110a, a time code unit 120, and a monitoring unit 130.

The media supply module 110a is used for supplying original scene information 160 and more than one piece of spare scene information 170. The media supply module 110a refers to hardware or a combination of more than one form of a unit, component, device, apparatus, and system combining software and hardware that has a media supplying capability.

The original scene information 160 is formed by multiple media frames. The spare scene information 170 provides a segment for replacing a part of the original scene information 160 or provides promotional data of the media frames included in the original scene information 160, for example, similar data for further explanation of the media frames such as a brief description of the played content of a media frame, playing durations, and titles.

The time code unit 120 respectively obtains an original scene time code 121 corresponding to the original scene information 160 and a spare scene time code 122 corresponding to the spare scene information 170. The monitoring unit 130 is enabled to search for, according to an obtained control signal, the spare scene time code 122 corresponding to the original scene time code 121 and replace the original scene information 160 with the spare scene information 170. In other words, if a user does not perform actions such as switching, replacement or pixelization processing on the content of a multimedia program when watching the program by using a device, apparatus or system with a media playing capability, the time code unit 120 only supplies the original scene time code 121 to the monitoring unit 130.

The monitoring unit 130 is provided with an input interface, so as to obtain user information and a control signal. A presentation end of the input interface depends on the demands of designers and is not limited. The user information means that a user must first input the user information to verify a user identity when using the monitoring unit 130 and according to the user identity, the user obtains a preceding usage record for reference of this operation of the scene control system. The user information may be in any form for identity authentication, for example, a text password, chip authentication or a fingerprint.

In addition, the monitoring unit 130 may be used by the user to download segments of the original scene information 160 to be played in advance, so that the user end can check the segments first and remove media frames unsuitable for playing. Alternatively, the monitoring unit 130 may accept or reject certain segments of the original scene information 160 according to the viewpoint and rating data of the general public on the original scene information 160. Moreover, the user may also store one's own personal rating data in the monitoring unit 130 for reference by others or as a viewpoint reference value for media data of the same type to be played later. In addition, the user may even use ratings, which are made by a social group to which the user belongs, on various programs as reference indexes in the user's own evaluation of the contents of the programs. When the user cannot perform direct filtering control on the program contents, the rating data can be directly adopted or the social evaluation indexes can be used as the reference for selection and replacement of program segments.

A digital multimedia device 150 includes a digital signal receiving unit 151 and a display unit 152. The digital signal receiving unit 151 receives program information of a digital television channel transmitted from the monitoring unit 130, so as to display, with the display unit 152, the original scene information 160 and the spare scene information 170 according to the original scene time code 121.

The original scene information 160 includes multiple media frames of different contents. For example, when the original scene information 160 is image data, the image data means image frames having more than one of contents such as targets, scenes and characters. In another example, when the original scene information 160 is voice data, the voice data means voice frames having more than one of contents such as high pitches, low pitches, speech and music.

The control signal refers to a retrieval demand condition input by a user when the user intends to retrieve a specific media frame from the original scene information 160. For example, when the original scene information 160 is images of news program pictures and the user sees program segments unsuitable for children or juveniles to watch, for example, violent, bloody, and erotic program segments, in the television news pictures, control signals of such retrieval demand conditions can be input through the monitoring unit 130 to remove such pictures, or to replace such pictures with advertisements or short video clips, or even to perform pixelization processing on such pictures. In another example, when the original scene information 160 is data of character dialogs of a television drama program, the user can input a control signal with the monitoring unit 130 to hide or silence this segment of program content, so as to prevent children or juveniles from learning the dialogs.

The monitoring unit 130 is formed of software, hardware or software and hardware, for example, application soft executed by an arithmetic processor, a chip, an integrated circuit (IC) or firmware that runs further in combination with a chip or an IC, which is not limited herein and depends on the demands of designers.

The monitoring unit 130 obtains the original scene information 160 and the spare scene information 170 supplied by the media supply module 110a. The monitoring unit 130 compares a switching demand condition of the control signal with each piece of original scene information 160, so as to obtain more than one piece of target original scene information 160, and then retrieves all target media frames corresponding to the target original scene information 160 from the obtained original scene information 160. However, the control signal may include more than one type of switching demand condition, and may also include multiple different switching demand conditions. The monitoring unit 130 retrieves multiple media frame groups from the original scene information 160 according to the switching demand conditions.

The monitoring unit 130 may generate one or more pieces of self-generated media with the retrieved target media frames according to similar rules such as a playing sequence, playing durations of the media frames in the original scene information 160, the sequence of the switching demand conditions. Alternatively, furthermore, a media playing tree structure is generated depending on data dependence relationships of the retrieval demand conditions or the type of data attributes. However, the interface of the monitoring unit 130 also presents input fields of the media playing tree structure, and the user merely inputs the retrieval demand conditions in the fields according to the data dependence relationships of the retrieval demand conditions or the types of the data attributes, which are used as the reference for retrieval and classification of the media frames by the monitoring unit 130.

In addition, the media supply module 110a also supplies a plurality of pieces of spare scene information 170 corresponding to each piece of original scene information 160, and supplies the original scene information 160 and the plurality of pieces of spare scene information 170 corresponding thereto to the monitoring unit 130. When inputting the control signal with the monitoring unit 130, the user may set a different switching demand condition for each piece of original scene information 160 or set one switching demand condition for all original scene information 160, which depends on demands of the user. The monitoring unit 130 compares spare scene information 170 that meets the switching condition according to the control signal, so as to find target spare scene information that meets the switching condition in the spare scene information 170, and then retrieves target media frames from each piece of original scene information 160 according to the target spare scene information that meets the switching condition in the spare scene information 170.

Subsequently, the monitoring unit 130 can be designed to generate playing media that meets the demand of the user with the target media frames or even the media frame groups formed of the target media frames.

In addition, the monitoring unit 130 can store retrieved results such as the target media frames, media frame groups, target spare scene information, media playing tree structure, and playing media in a storage module for use by the monitoring unit 130 during a next retrieval operation. Furthermore, the playing media generated through the media retrieval operation can be directly selected and played by a playing module in the system.

Currently, according to a television viewing habit, a user generally switches the channel upon seeing an inappropriate program content when watching a program, and after switching the channel, if the user sees an inappropriate program content again, the user continues to switch the channel. However, the content of a television program usually cannot be directly manipulated by audiences, and currently, indecent program contents can only be avoided through passive channel switching. However, with the advent of the digital television era, the opportunity for solving the preceding problem emerges.

As is generally known, digital television has been fully launched. The so-called digital television is different from conventional analog television in terms of signal form. Apart from that, a major advantage of the digital television is the diversity of information. The digital television not only supports various access modes, use of the Internet protocol (IP), and various encoding and decoding functions, but also provides service functions such as video on demand, network browsing, and interactive games to form a home digital platform of a digital television system, which is further expanded into interactive services of multimedia digital contents. Under such conditions, a television program playing mode, which not only meets demands of users but also avoids playing of program contents unsuitable for watching, can be provided through the scene control in the present specification.

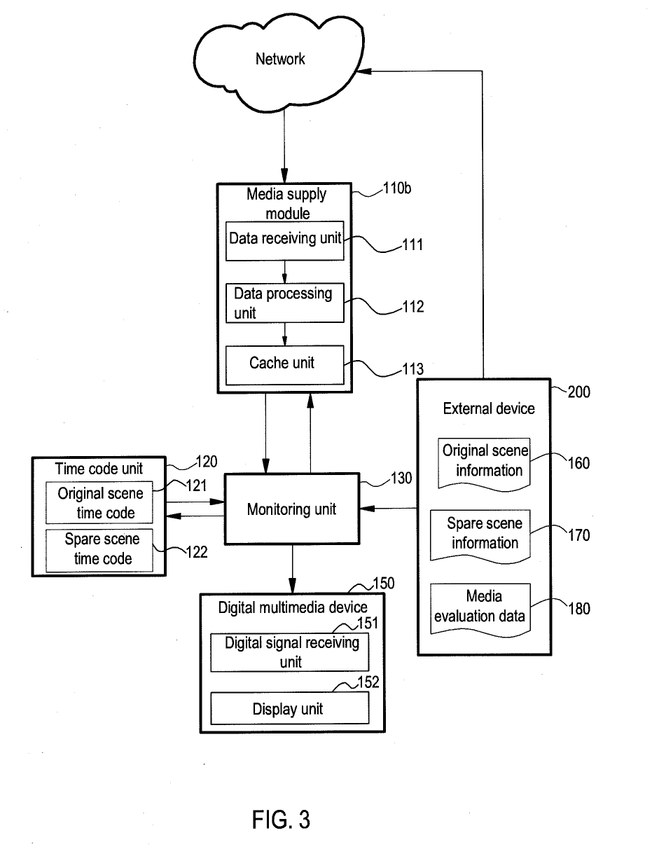

FIG. 3 is a first detailed schematic structural view of a scene control system according to an embodiment of the present invention. In this embodiment, a media supply module 110b includes a data receiving unit 111, a data processing unit 112, and a cache unit 113. The data receiving unit 111 does not store the original scene information 160 and the spare scene information 170, and instead obtains the original scene information 160, the spare scene information 170, and media evaluation data 180 through the connection to an external device 200 or a network.

The media supply module 110b supplies the obtained original scene information 160, spare scene information 170, and media evaluation data 180 to the monitoring unit 130.

According to the original scene information 160, the spare scene information 170, and the media evaluation data 180, the monitoring unit 130 enables a user to input, according to the original scene information 160, the spare scene information 170, and the media evaluation data 180, a corresponding control signal into the monitoring unit 130. According to the control signal, the monitoring unit 130 then supplies media data formed by the original scene information 160 and the spare scene information 170 and an adjusted media time code. The obtained original scene information 160 and the spare scene information 170 may be stream media or integral video/audio data.

When the original scene information 160 is stream media, the data processing unit 112 directly transmits the received media frames or media segments to the monitoring unit 130, so that the monitoring unit 130 performs a media retrieval action according to the retrieved data. If the original scene information 160 is integral video/audio data, the data processing unit 112 stores the received segment data in the cache unit 113, and then supplies the original scene information 160 to the monitoring unit 130 after receiving the original scene information 160.

The digital signal receiving unit 151 of the digital multimedia apparatus 150 receives a digital television signal from the monitoring unit 130, so as to display, with the display unit 152, the original scene information 160 and the spare scene information 170 in sequence according to the adjusted time code data.

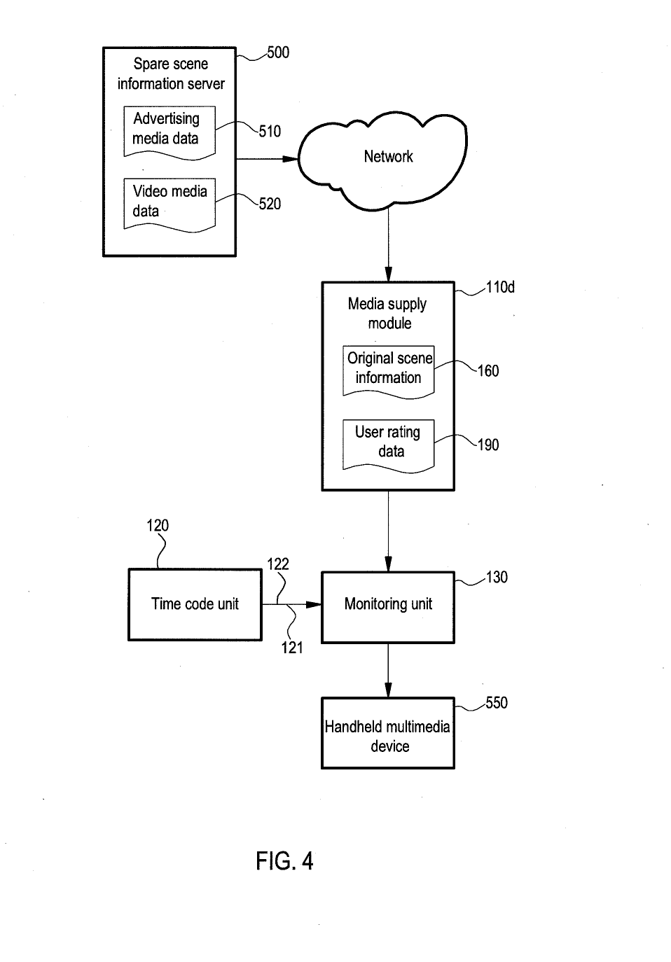

FIG. 4 is a second detailed schematic structural view of a scene control system according to an embodiment of the present invention. Different from the preceding embodiment, a media supply module 110d in this embodiment is connected to a spare scene information server 500, and the media supply module 110d has user rating data 190. The user rating data 190 is the data based on the television viewing habit of a user and former ratings.

The spare scene information server 500 stores one or multiple pieces of advertising media data 510 and video media data 520. When supplying the original scene information 160 according to the control signal, the media supply module 110d obtains advertising media data 510 and video media data 520 corresponding to the original scene information 160 from the spare scene information server 500, and supplies the original scene information 160 and the advertising media data 510 and video media data 520 corresponding thereto to the monitoring unit 130.

In this embodiment, a handheld multimedia device 550 refers to a general handheld electronic device capable of playing multimedia data, for example, a handheld electronic device like a personal digital assistant (PDA), a smart phone, and a tablet computer.

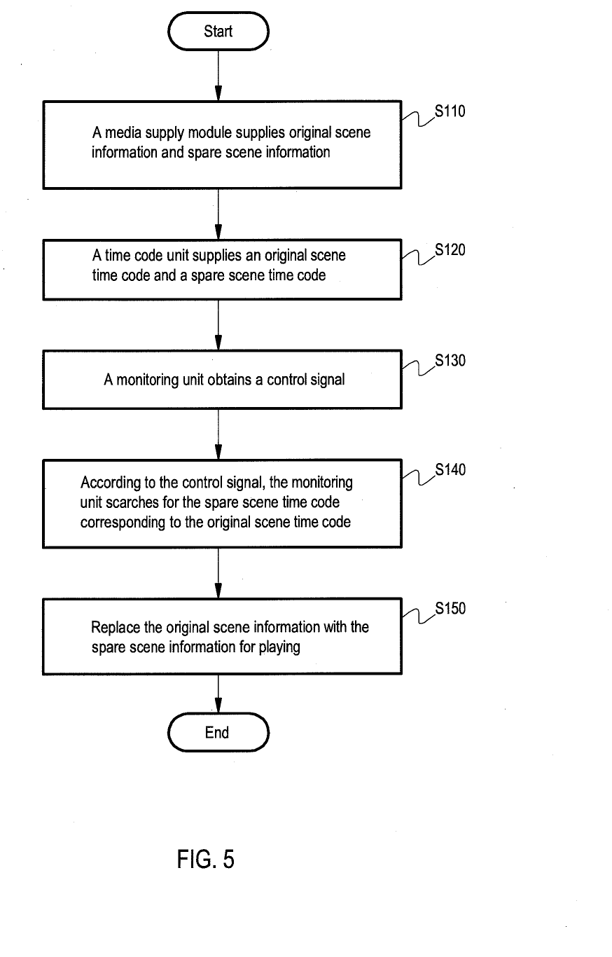

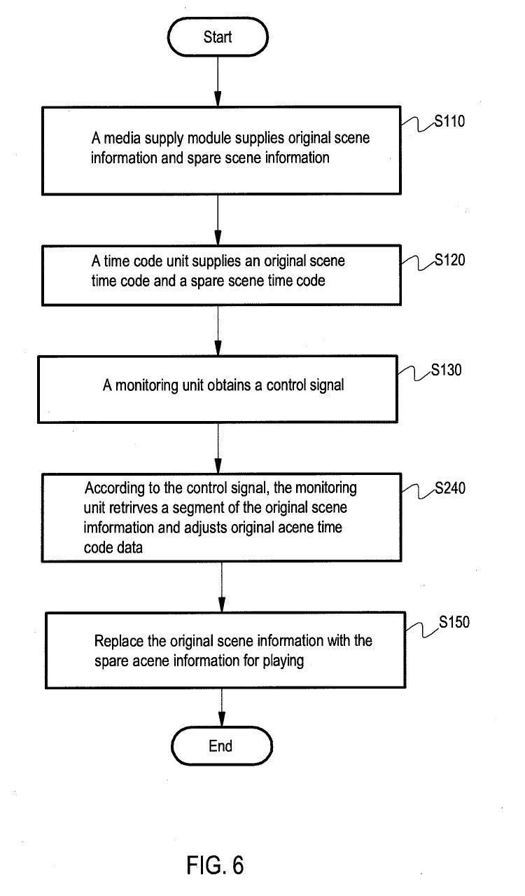

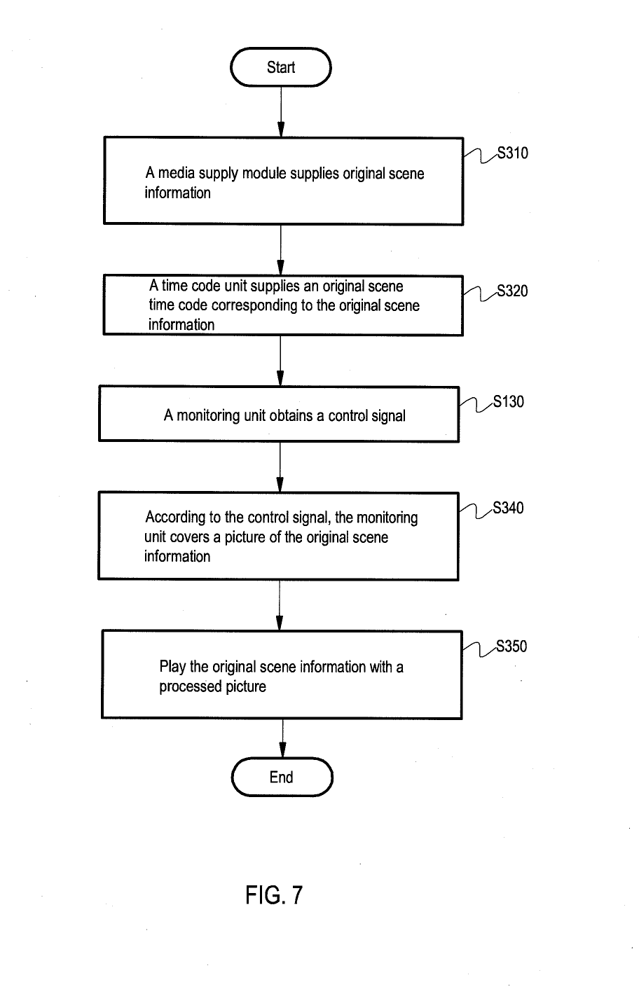

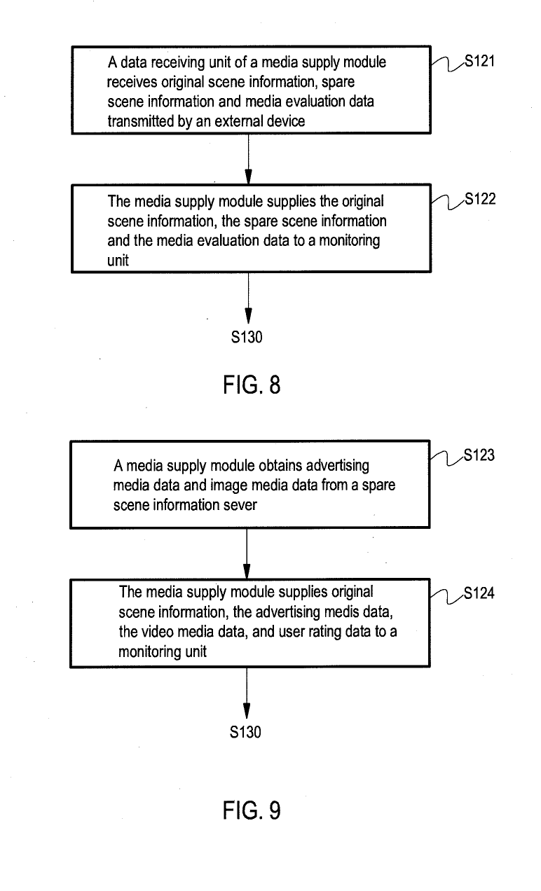

FIG. 5 is a schematic process flow chart of a scene control method corresponding to FIG. 2. FIG. 6 is another schematic process flow chart of a scene control method corresponding to FIG. 3. FIG. 7 is yet another schematic process flow chart of a scene control method corresponding to FIG. 4. FIG. 8 and FIG. 9 are detailed schematic flow charts of a scene control method according to an embodiment of the present invention. Refer to FIG. 1 to FIG. 4 in combination for ease of comprehension. The process of the method is as follows.

A media supply module 110a supplies original scene information 160 and spare scene information 170 (Step S110). According to different manners selected by a monitoring unit 130, the spare scene information 170 is not necessarily supplied for the combination with the original scene information 160. Therefore, this step is different according to the detailed implementation of the monitoring unit 130.

A time code unit 120 respectively obtains, according to the original scene information 160 and the spare scene information 170, an original scene time code 121 corresponding to the original scene information 160 and a spare scene time code 122 corresponding to the spare scene information 170 (Step S120). The monitoring unit 130 adjusts the original scene time code 121 according to a control signal. In other words, if a user does not perform switching, replacement or pixelization processing on the content of a multimedia program when watching the program by using a device, apparatus or system with a media playing capability, the time code unit 120 only supplies the original scene time code 121 to the monitoring unit 130.

That the monitoring unit 130 obtains a control signal (Step S130) refers to a data input interface for the user to input data. A presentation end of the interface depends on the demands of designers and is not limited. The data input interface at least provides control keys for switching, film editing and pixelization processing, so that a user can monitor the content of a program while watching the program. Once a picture unsuitable for watching is found, the picture can be processed.

According to different switching demand conditions, reference sources for the user to input a control signal with the monitoring unit 130 are different, which are described as follows. In this step, the monitoring unit 130 compares each piece of original scene information 160 according to the control signal downloaded in advance to find at least one piece of target spare scene information 170 that matches the control signal. According to different manners of supplying the original scene information 160 and the spare scene information 170, the detailed implementation of this step is also different.

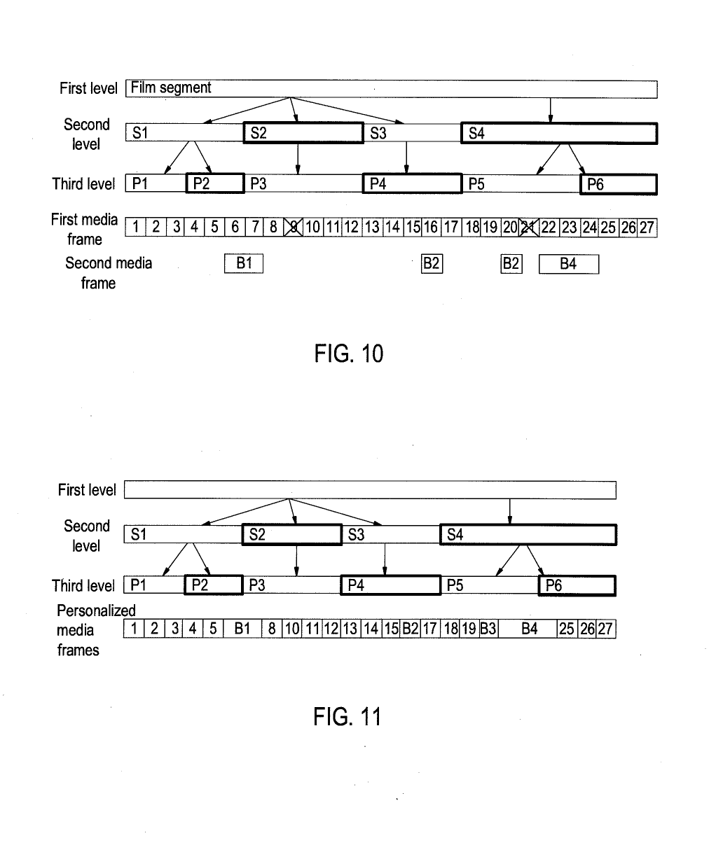

As shown in FIG. 3, a media supply module 110b is to be connected to an external device 200. The external device 200 supplies original scene information 160, spare scene information 170, and media evaluation data 180. The media supply module 110b is merely a medium for receiving and forwarding data. The detailed implementation of this step is shown in FIG. 8. A data receiving unit 111 of the media supply module 110b receives the externally transmitted original scene information 160, spare scene information 170 and media evaluation data 180 (Step S121). The media supply module 110b supplies the original scene information 160, the spare scene information 170 and the media evaluation data 180 to a monitoring unit 130. (Step S122), so that the monitoring unit 130 selects, according to the media evaluation data 180, a segment of the original scene information 160 and replaces the segment of the original scene information 160 with the spare scene information 170, or edits a part of the original scene information 160 (Step S240) (please refer to FIG. 10 and FIG. 11).

In this embodiment, it is mainly described that when a user sometimes sees very explicit pictures while watching a live program, for example, news, the user can directly deliver a control command with the monitoring unit 130, so as to directly switch the picture data being played and replace the original scene information 160 being played with the spare scene information 170.

Refer to devices shown in FIG. 4 for comprehension of steps shown in FIG. 7. A media supply module 110d supplies original scene information 160 and user rating data 190 (S310), and the media supply module 110d is connected to a spare scene information server 500. A spare scene time code corresponding to the original scene information 160 is obtained (Step S320). A monitoring unit covers an original picture according to a control signal (Step S340), for example, through pixelization processing. Further, the original picture may also be covered by a spare picture. The spare picture can be obtained from one or more pieces of advertising media data 510 and video media data 520 stored in the spare scene information server 500. The detailed implementation of this step is shown in FIG. 9: when supplying the original scene information 160, the media supply module 110d obtains from the spare scene information server 500 one or more pieces of corresponding advertising media data 510 and video media data 520 (Step S123) and supplies the one or more pieces of advertising media data 510 and video media data 520 to a monitoring unit 130 for replacement (Step S124). Finally, the original scene information with a processed picture is played (Step S350).

The monitoring unit 130 compares the switching demand condition of the control signal with each piece of original scene information 160, so as to obtain more than one piece of target original scene information 160, and then retrieves all target media frames corresponding to the target original scene information 160 from the obtained original scene information 160. However, the control signal may include more than one type of switching demand condition and may include multiple different switching demand conditions. The monitoring unit 130 retrieves multiple media frame groups from the original scene information 160 according to the switching demand conditions.

The method further includes: generating, by the monitoring unit 130, a media playing tree structure with each target media frame corresponding to each retrieval demand condition according to data dependences of the retrieval demand conditions, data attributes and data level relationships.

FIG. 10 and FIG. 11 are schematic views of a media playing tree structure according to an embodiment of the present invention. Herein, by combining the data dependence relationships of the original scene information 160 or the types of the data attributes, a media playing tree structure may be generated with media frames or metadata of the whole original scene information 160.

The first level of the media playing tree structure refers to the whole program images.

The second level refers to the segments of the first level program, which are programs images of the segments. The third level refers to the branches of the second level images, which are unit images of the program. The fourth level refers to the branches of the third level images, which are close-up shot images in the unit images.

After the user sets control signal , the monitoring unit 130 retrieves media frames to be switched or edited from the original scene information 160 through the media playing tree structure according to a switching demand condition included in the control signal, so as to form the above self-generated images to be played by a relevant playing module.

For example, if a user intends to edit or replace a segment of the close-up shot images at the fourth level, a matching segment can be found through comparison from the one or more pieces of advertising media data 510 and video media data 520 to replace the segment. If the user intends to directly remove this segment, a next close-up video can be directly played in advance. Apart from that, the user may also perform pixelization processing on the pictures thereof.

In the above processing, only the manner of removing the segment may influence the original duration of the video, and the original duration is not influenced by other manners. However, the original scene time code corresponding to the original scene information is definitely different from the original schedule. Therefore, as long as an operation is performed through the control signal of the monitoring unit, adjusted media data and a time code corresponding to the media data are definitely generated from the played content of original scenes and the original scene time code corresponding thereto.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A scene control system, comprising:
a media supply module, used for supplying original scene information and spare scene information;
a time code unit, used for respectively obtaining an original scene time code corresponding to the original scene information and a spare scene time code corresponding to the spare scene information; and
a monitoring unit, used for obtaining user information and a control signal, and according to the user information and the control signal, searching for the spare scene time code corresponding to the original scene time code, and replacing the original scene information with the spare scene information.

2. The scene control system according to claim 1, wherein the media supply module further comprises a preloading procedure to download the original scene information not played yet in advance, so that the monitoring unit checks the original scene information not played yet and generates the control signal.

3. The scene control system according to claim 1, wherein the media supply module further supplies multiple pieces of spare scene information from different sources, so that the pieces of spare scene information are inserted into the original scene information according to the control signal.

4. The scene control system according to claim 3, further comprising an external device connected to the media supply module, wherein the external device supplies the original scene information, the at least one piece of spare scene information, and media evaluation data to the monitoring unit.

5. The scene control system according to claim 3, further comprising a spare scene information server connected to the media supply module, wherein when the media supply module supplies the spare scene information, the media supply module obtains, according to user rating data of the media supply module, the spare scene information from the spare scene information server, so as to supply each piece of spare scene information to the monitoring unit.

6. The scene control system according to claim 1, wherein the monitoring unit removes a segment of the original scene information according to the control signal.

7. The scene control system according to claim 1, wherein the media supply module comprises a data receiving unit, used for receiving the externally transmitted original scene information, so as to supply the externally transmitted original scene information to the monitoring unit.

8. The scene control system according to claim 1, further comprising a storage module, wherein the storage module stores at least one original scene data list, the monitoring unit obtains a time code corresponding to the control signal from the storage module, obtains at least one piece of target original scene information from the pieces of original scene information according to the control signal, and retrieves at least one target media frame corresponding to the at least one piece of target original scene information.

9. A scene control method, comprising:
supplying, by a media supply module, original scene information and spare scene information;
respectively obtaining, by a time code unit, an original scene time code corresponding to the original scene information and a spare scene time code corresponding to the spare scene information;
obtaining, by a monitoring unit, a control signal;
according to the control signal, searching for, by the monitoring unit, the spare scene time code corresponding to the original scene time code; and
replacing the original scene information with the spare scene information for playing.

10. The scene control method according to claim 9, further comprising a preloading procedure, wherein the preloading procedure comprises the following steps of downloading the original scene information not played yet in advance; and
checking, by the monitoring unit, the original scene information not played yet and generating the control signal.

11. The scene control method according to claim 9, wherein the step of obtaining, by a monitoring unit, a control signal comprises:
receiving, by a data receiving unit of the media supply module, user information, the original scene information, the spare scene information, and media evaluation data transmitted by an external device;
supplying, by the media supply module, user information, the original scene information, the spare scene information and the media evaluation data to the monitoring unit; and
obtaining the control signal according to the original scene information, the spare scene information and the media evaluation data.

12. The scene control method according to claim 9, wherein the step of obtaining, by a monitoring unit, a control signal comprises:
obtaining, by the media supply module, media data and video media data from a spare scene information server;
supplying, by the media supply module, the original scene information, the media data, the video media data, and user rating data to the monitoring unit; and
obtaining the control signal according to the original scene information, the spare scene information, and the media evaluation data.

13. A recording medium, storing a program code to be read by an electronic device, wherein when reading the program code, the electronic device executes a scene control method, and the method comprises the following steps of:
supplying, by a media supply module, original scene information and spare scene information;
respectively obtaining, by a time code unit, an original scene time code corresponding to the original scene information and a spare scene time code corresponding to the spare scene information;
obtaining, by a monitoring unit, a control signal;
according to the control signal, searching for, by the monitoring unit, the spare scene time code corresponding to the original scene time code; and
replacing the original scene information with the spare scene information for playing.

14. The recording medium according to claim 13, wherein the step of supplying, by a media supply module, original scene information comprised in the method comprises:
supplying, by the media supply module, at least one piece of spare scene information.

15. The recording medium according to claim 14, wherein the step of supplying, by a media supply module, original scene information and the at least one piece of spare scene information comprised in the method comprises:
continuously receiving, by a data receiving unit of the media supply module, externally transmitted media frames and original scene information corresponding to each media frame; and
supplying the media frames and the original scene information corresponding to each media frame to the monitoring unit.

16. The recording medium according to claim 14, wherein the step of supplying, by a media supply module, original scene information and the at least one piece of spare scene information comprised in the method comprises:
obtaining, by the media supply module, spare scene information corresponding to each media frame from a spare scene information server; and
supplying, by the media supply module, the media frames and the spare scene information corresponding to each media frame to the monitoring unit.
